(19) United States
(12) Patent Application Publication
(10) Pub. No.: US 2024/0376863 A1
(43) Pub. Date: Nov. 14, 2024

(54) IMPROVEMENTS IN THE CONSTRUCTION AND MAINTENANCE OF WIND TURBINES

(71) Applicant: Wind Spider AS, Stavanger (NO)

(72) Inventors: Per Olav Haughom, Tonstad (NO); Petter Vabø, Hafrsfjord (NO)

(73) Assignee: Wind Spider AS, Stavanger (NO)

(21) Appl. No.: 18/683,608

(22) PCT Filed: Aug. 15, 2022
(86) PCT No.: PCT/NO2022/050194

§ 371 Date: Feb. 14, 2024

(30) Foreign Application Priority Data
Aug. 16, 2021 (NO) 20210981
Mar. 2, 2022 (NO) 20220266

(51) Int. Cl. F03D 13/10; F03D 13/20

(52) U.S. Cl. CPC F03D 13/139; F03D 13/201; F05B 2230/61; F05B 2240/95

(57) ABSTRACT

Methods are for extending a crane tower along a wind turbine, assembling a crane tower, shortening a crane tower, and constructing a wind turbine tower, in addition to various related apparatus. In certain examples, a crane tower is supported upon the wind turbine tower and extended along the wind turbine tower, where the crane tower includes a crane at or near an upper end thereof, and the wind turbine tower is provided with apparatus including a lifter to elevate the crane tower to create space for inserting one or more extension sections at or near a crane tower base and adding them to the crane tower for extending the crane tower longitudinally along the wind turbine tower.

### CROSS-REFERENCE TO RELATED APPLICATIONS

This application is the U.S. national stage application of International Application No. PCT/NO2022/050194, filed Aug. 15, 2022, which international application was published on Feb. 23, 2023 as WO 2023/022600 A1 in the English language. The International Application claims priority to Norwegian patent application No. 20210981, filed Aug. 16, 2021, and Norwegian patent application No. 20220266, filed Mar. 2, 2022. The international application and Norwegian applications are all incorporated herein by reference, in their entirety.

### FIELD

The present invention relates in particular to the installation, construction and maintenance of wind turbines.

### BACKGROUND

A modern wind turbine generally comprises a tower upon which blades connected to a rotary hub are supported on an upper end. The blades are coupled to a generator through a shaft and bearings arrangement at the top of the tower. In use, the blades are caused to turn by the wind which in turn produces rotation of a shaft and allows electricity to be produced by the generator. In addition to the generator, auxiliary equipment, such as a transformer and control and monitoring systems, is typically provided. The top structure, referred to as a nacelle, is typically supported on the tower with bearings, so that the nacelle can be rotated around a vertical axis of the tower and be adjusted to varying wind directions. The blades are coupled to the nacelle.

Wind turbines have developed from small land-based wind turbines of 200-300 kW to today's larger turbines of about 10 MW. Apart from differences of scale, the configuration of wind turbines has largely kept to the same general design over many years. Current developments include floating wind turbines capable of producing installed power of up to 15-20 MW.

In today's wind turbines, the nacelle is typically built as an assembled structure which can then be hoisted onto the top of the tower structure when the tower structure has been assembled to its full height. Wind turbines of about 10 MW generally have a tower height of about 200 m and the nacelle can weigh 300-400 tonnes. A nacelle of 300-400 tonnes to be lifted about 200 m up typically requires large and expensive hoisting devices. Lifts of this kind can be particularly challenging in the case of floating wind turbines where the hoisting device on a floating base can be affected by wave movements. The time intervals for acceptable wave conditions are often very short. Installation of floating wind turbines can be technically highly demanding and costly.

On land, the development of wind farms may impinge upon the surrounding infrastructure and environment. Access to installation sites on roads may be difficult and road networks may not be well suited for transporting wind turbine components and heavy cranes, especially where such components may be long and cumbersome, and especially to remote sites.

The tower structure of a wind turbine is often cylindrical and installed by cylindrical tower sections which are bolted together. Thereafter, the nacelle and the blades are added. Tower climber devices may be employed for providing access and assisting with the assembly process. The climber device may typically travel up/down the tower and grip/release sections of the tower structure in the necessary locations along the tower structure as it climbs up/down. Climbers can thus involve technical complexity and operational limitations that may render them technically unsuitable or an unattractive option in some projects.

In many designs, the sections of the tower structure are tapered toward the upper end. Thus, the tower to be constructed may be wider at the lower end and may gradually become narrower toward the upper end. This can pose significant difficulties in that the diameter changes along its length and different diameters need to be accommodated in different sections of the tower. Furthermore, different wind turbine towers may have a different angle of taper. The inventor has noted that the tapered configuration of the wind turbine tower can pose significant engineering difficulties which may prevent or hamper the effectiveness of existing solutions for assembly or maintenance of the wind turbine from being applied, as for example can be found in various solutions based upon climber devices.

### SUMMARY

Amongst the aims and objectives of the present invention it is sought to obviate or at least mitigate one or more drawbacks of prior art.

According to a first aspect of the invention, there is provided a method of extending a crane tower along a wind turbine tower, the method comprising the steps of: providing a crane tower to be extended along at least a portion of a wind turbine tower, the crane tower comprising one or more crane tower sections and a crane at or near an upper end thereof, and providing a support means and at least one lifter; locating the crane tower in a base position, in which a lower end of the crane tower is arranged at or near a crane tower base; operating the lifter to elevate the crane tower away from the crane tower base toward an elevated position, thereby creating space for extension tower sections to be inserted at or near the crane tower base; locating and supporting the crane tower in the elevated position; arranging one or more extension sections in the created space; and adding the one or more extension sections to a lower end of the elevated crane tower, thereby extending the crane tower.

The method may further comprise one or more further features as set out in any of the dependent claims 2 to 29 of the claims appended hereto.

The crane tower base may comprise a platform and or the ground. The platform may be supported upon the foundation or the ground. The platform may be connected to the wind turbine tower. The foundation may be a floating foundation. The foundation may be a bottom fixed offshore foundation, a floating foundation or a ground supported foundation.

According to a second aspect of the invention, there is provided a method of assembling a crane tower, the method comprising the steps of: providing a crane to be raised along at least a portion of a wind turbine tower and at least one lifter; locating the crane in a base position, in which a lower end of the crane is arranged at or near a crane tower base; operating the lifter to elevate the crane away from the crane tower base toward an elevated position, thereby creating space for crane tower sections to be inserted at or near the crane tower base; locating and supporting the crane in the elevated position; arranging one or more crane tower sections in the created space; adding the one or more crane tower sections to a lower end of the elevated crane; and connecting the crane to the one or more crane tower sections.

The crane tower assembled according to the second aspect, may further be extended by performing the method described in the first aspect.

According to a third aspect of the invention, there is provided apparatus for facilitating in performing one of an assembling operation, a modification operation and a maintenance operation on a wind turbine, the apparatus comprising: parts for forming a crane tower section to extend circumferentially at least partially around a wind turbine tower section; crane parts for providing a crane configured to be coupled to and supported upon an upper end of the crane tower section; parts for forming an extension section to extend circumferentially at least partially around a wind turbine tower section; parts for forming a support structure to extend circumferentially at least partially around a wind turbine tower section; means for providing a lifter for advancing a crane tower including the crane tower section and the crane away from or towards a first, base position along a wind turbine tower; and means for supporting the crane tower in a second position.

The apparatus may further comprise one or more further features as set out in any of the dependent claims 33 to 35 of the claims appended hereto.

According to a fourth aspect of the invention, there is provided a method of extending a crane tower along a portion of a wind turbine tower, the method comprising the step of inserting one or more extension sections to extend the crane tower with respect to the crane tower base along the wind turbine tower.

The method may further comprise one or more further features as set out in any of the dependent claim 37 or 38.

According to a fifth aspect of the invention, there is also provided a method of extending a crane tower upon a portion of a wind turbine tower, comprising the steps of: elevating the crane tower to be lengthened to create insertion space for one or more extension sections; inserting the one or more extension sections into the created space to extend the crane tower with respect to the crane tower base along the wind turbine tower; and connecting the one or more extension sections to the crane tower.

According to a sixth aspect of the invention, there is provided a method of shortening a crane tower supported on a wind turbine tower, the method comprising the steps of: providing the crane tower to be shortened, the crane tower comprising two or more crane tower sections and a crane at or near an upper end thereof, and providing at least one lifter and support means; locking an upper part of the crane tower to the support means; removing a bottom extension section from the crane tower; and operating the lifter to lower the upper part of the of the crane tower.

According to a seventh aspect of the invention, there is provided a crane obtained by the method according to the first or second aspect of the invention.

According to an eighth aspect of the invention, there is provided a wind turbine under installation, modification or maintenance provided with a crane tower or extended crane tower obtained by performing the method according to the first or second aspect of the invention.

According to a ninth aspect of the invention, there is provided apparatus for extending a crane tower upon a wind turbine tower, the apparatus comprising: equipment to facilitate inserting one or more extension sections to extend the crane tower with respect to the crane tower base along the wind turbine tower.

The apparatus may further comprise one or more further features as set out in any of the dependent claims 43 to 47.

According to a tenth aspect of the invention, there is provided apparatus for extending a crane tower upon a partially constructed wind turbine tower, the apparatus comprising: equipment to facilitate inserting one or more extension sections to extend the crane tower with respect to the crane tower base along the wind turbine tower, wherein the equipment comprises a lifter to elevate the crane tower to be extended away from the crane tower base to create an insertion space for the one or more extension sections at or near the crane tower base. According to an eleventh aspect of the invention, there is provided a method of constructing a wind turbine tower, the method comprising the steps of: providing a crane tower to be extended along the wind turbine tower under construction, the crane tower being supported upon a partially constructed portion of the wind turbine tower, the crane tower comprising one or more crane tower sections and a crane at or near an upper end thereof, the partially constructed portion of the wind turbine tower being equipped with apparatus comprising at least one lifter and support means; locating the crane tower in a base position, in which a lower end of the crane tower is arranged at or near and in weight bearing relationship upon a crane tower base, the weight of the crane tower at least partially transmitted to the partially constructed portion of the wind turbine tower through the crane tower base; using the crane tower in work mode, operating the crane to locate and position a further wind turbine tower section in longitudinal orientation above an upper end of the partially constructed portion of wind turbine tower, and connecting the further wind turbine tower section to the upper end; operating the lifter to elevate the crane tower away from the crane tower base toward an elevated position, thereby creating space for extension tower sections to be inserted at or near the crane tower base; locating the crane tower in the elevated position, locking the crane tower to the support means, the weight of the crane tower at least partially transmitted to the partially constructed portion of the wind turbine tower through the support means and optionally further through the crane tower base; arranging one or more extension sections in the created space in an area around the partially constructed portion of the wind turbine tower; adding the one or more extension sections to a lower end of the elevated crane tower, thereby lengthening the crane tower; locating the lengthened crane tower in the base position, in which a lower end of the lengthened crane tower is arranged at or near and in weight bearing relationship upon the crane tower base, the weight of the lengthened crane tower at least partially transmitted to the partially constructed portion of tower through the crane tower base; and using the lengthened crane tower in work mode, operating the crane to locate and position a further wind turbine tower section in longitudinal orientation above an upper end of the previously connected tower section of the wind turbine tower, and connecting the further wind turbine tower section to the upper end.

Typically, the method further comprises: operating the lifter to elevate the lengthened crane tower away from the crane tower base to an elevated position, thereby creating space for further extension sections to be inserted at or near the crane tower base; locating the lengthened crane tower in the elevated position, locking the lengthened crane tower to the support means, the weight of the lengthened crane tower at least partially transmitted to the partially constructed portion of the wind turbine tower through the support means and optionally through the crane tower base; arranging one or more further extension sections in the created space in the area around the partially constructed portion of the wind turbine tower; adding the one or more further extension sections to a lower end of the elevated crane tower, thereby further lengthening the crane tower; locating the further lengthened crane tower in the base position, in which a lower end of the further lengthened crane tower is arranged at or near and in weight bearing relationship upon the crane tower base, the weight of the further lengthened crane tower at least partially transmitted to the partially constructed portion of wind turbine tower through the crane tower base; and using the further lengthened crane tower in work mode, operating the crane to locate and position a yet further wind turbine tower section in longitudinal orientation above an upper end of the previously connected tower section of the wind turbine tower, and connecting the yet further wind turbine tower section to the upper end.

The method may further comprise connecting at least two parts to assemble the extension section or sections, which may extend circumferentially at least partially around the partially constructed portion of the wind turbine tower.

Typically, the one or more extension sections are cylindrical sections arranged to extend around and longitudinally along the partially constructed wind turbine tower.

The method may further comprise connecting at least two parts to assemble the crane tower section or sections, which may extend at least partially around the partially constructed portion of the wind turbine tower.

Typically, the one or more crane tower sections are cylindrical sections arranged to extend around and longitudinally along the partially constructed wind turbine tower.

The method may include connecting the extension tower section or sections fixedly to a lower end tower section of the crane.

The support means may comprise or be a support frame, and the method may include connecting at least two components to assemble the support frame which may extend circumferentially at least partially around the partially constructed portion of the wind turbine tower.

Typically, the support frame is a cylindrical support frame arranged to extend around and longitudinally along the partially constructed wind turbine tower.

Typically, the lifter comprises a carriage arranged to travel longitudinally to move the crane tower from the base position to the elevated location.

Typically, the lifter is arranged to extend circumferentially at least partially around the partially constructed portion of the wind turbine tower.

The support means typically comprises a support frame which extends in a circumferential direction at least partially around the partially constructed portion of the wind turbine tower, and the lifter is typically arranged to extend circumferentially at least partially around an outside of the support frame. A lower end crane tower section of the tower being elevated may be arranged in an annular region between an inward surface of the carriage and an outward surface of the support frame. Alternatively or in addition, the lower end crane tower section of the tower being elevated may be arranged in abutment with an upward facing surface of the carriage. The lower end crane tower section may be engaged by the carriage, and the carriage may be movable up/down along the support frame.

The lifter or carriage may have a distance of travel corresponding to the end-to-end length of one wind turbine tower section. The one or more extension sections each typically have lengths matching the one or more further sections of wind turbine tower, e.g. approximately equal in length. This may reduce the number of lifting or elevation iterations needed to extend the crane tower to a desired reach along the wind turbine tower. The lifter or carriage may travel no further, or may not need to travel further, than approximately one wind turbine tower section length away from the crane tower base, e.g. platform. The lifter or carriage may be operable to travel away from the crane tower base so that the distance between the crane tower base and the carriage is approximately equal to the end-to end length of one wind turbine tower section.

The carriage may be hoisted or lowered on a winch line from a winch drum.

The partially constructed tower portion may have a work platform providing the crane tower base.

The winch drum may be located on the work platform. The winch line may be passed over a suspending member on the support frame.

The step of locking the crane tower to the support means may be performed by locking the elevated crane tower to the support frame.

The wind turbine tower may be an offshore wind turbine tower.

The crane tower sections may be provided with one or more radial standoff arms extending in a radial direction to bear against an outer surface of the wind turbine tower for providing lateral standoff between the crane tower and the wind turbine tower.

According to a twelfth aspect of the invention there is provided apparatus for facilitating in assembling a wind turbine tower, the apparatus comprising: at least two parts for forming a crane tower section to extend circumferentially at least partially around a wind turbine tower section; crane parts for providing a crane configured to be coupled to and supported upon an upper end of the crane tower section; at least two parts for forming an extension section to extend circumferentially at least partially around a wind turbine tower section; at least two parts for forming a support structure to extend circumferentially at least partially around a wind turbine tower section; means for arranging the crane tower upon the tower for lengthening the crane tower; means for providing a lifter for advancing a crane tower including the crane tower section and the crane away from a first, base position along a partially constructed portion of the wind turbine tower toward a second position; support means and locking means for locking the crane tower in the second position to the support means for securing the crane tower in the second position.

The apparatus may further comprise a winch having a winch wire, for operating the lifter.

The parts for forming the extension section may comprise parts for forming an extension section that is cylindrical; the parts for forming the crane tower section may comprise parts for forming a crane tower section that is cylindrical; and the parts for forming the support structure may comprise parts for forming a support structure that is cylindrical.

The parts for forming the extension section or the crane tower section may be arranged to be assembled to form an extension section or a crane tower section to extend at least partially around an outside of the support structure and be movably disposed for movement longitudinally along the support structure in the process of adding one or more extension or further extension sections to the crane tower.

The apparatus may further comprise at least two parts for forming the lifter to extend circumferentially at least partially around a wind turbine tower section.

The parts for forming the lifter are configured to form a lifter to extend around an outside of the support structure and be movably disposed for movement longitudinally along the support structure in the process of moving the crane tower away from the first, base position toward the second position for allowing the extension section to be added.

According to a thirteenth aspect of the invention, there is provided a method of extending a crane tower upon a partially constructed portion of the wind turbine tower, the method comprising the step of inserting one or more extension sections to extend the crane tower with respect to the crane tower base along the wind turbine tower under construction. Preferably, the extension sections are inserted at or near a crane tower base.

Typically, the method further comprises elevating the crane tower to be lengthened to create insertion space for the extension sections, inserting the extension section or sections into the created space, and connecting the extension section or sections to the crane tower.

According to a fourteenth aspect of the invention, there is provided apparatus for extending a crane tower upon a partially constructed wind turbine tower, the apparatus comprising: equipment to facilitate inserting one or more extension sections, preferably at or near a crane tower base, to extend the crane tower with respect to the crane tower base along the wind turbine tower under construction.

Typically, the equipment is operable to create insertion space for the extension sections. Typically also, the insertion space is created in an area around the partially constructed portion of the wind turbine. Typically, the insertion space is at or near the crane tower base.

Typically, the equipment includes a lifter to elevate the crane tower to be extended away from the crane tower base to an elevated position to create the insertion space.

Typically, the equipment includes support means and locking means to lock the crane tower in the elevated position to the support means.

The lifter may be disengageable from the locked crane tower in the elevated position.

The apparatus may include the crane tower to be extended.

The apparatus may include the crane tower base.

Typically, the crane tower base is or comprises a platform.

The wind turbine tower may be a floating wind turbine tower. The wind turbine tower may be a wind turbine tower as described anywhere else herein.

According to a fifteenth aspect of the invention, there is provided a system comprising: a crane tower to be supported upon a partially constructed wind turbine tower and one or more extension sections to extend the crane tower.

According to a sixteenth aspect of the invention, there is provided a system comprising apparatus which is arranged and supported upon a crane tower base of partially constructed wind turbine tower, the apparatus being operable to extend crane tower with respect to the crane tower base along the wind turbine tower under construction.

Any of the various aspects of the invention may include further features as described in relation to any other aspect of the invention, wherever described herein. Accordingly, the method, apparatus, crane, wind turbine tower, and/or system of the various aspects set out above may further comprise further features or steps as set out in relation to the method, apparatus, crane, wind turbine tower, and/or system of any other aspect. The apparatus, crane, wind turbine tower, or system of any aspect can further comprise corresponding features to those of any steps of any method, and vice versa.

In particular, the crane tower base where mentioned in relation to any of the method, apparatus, crane, wind turbine tower, and/or system of any of the various aspects set out above may comprise a platform and/or the ground. The platform may be supported upon a foundation or the ground. The platform may be connected to the wind turbine tower. The foundation may be a floating foundation. The foundation may be a bottom fixed offshore foundation, a floating foundation or a ground supported foundation.

Embodiments of the various aspects of the invention may be advantageous in various ways as will be apparent herein throughout.

### BRIEF DESCRIPTION OF THE DRAWINGS

There will now be described, by way of example only, embodiments of the invention, with reference to the accompanying drawings, in which:

FIG. 1 is a front representation of a fully constructed wind turbine;

FIG. 2 is a side representation of the wind turbine of FIG. 1;

FIG. 3 is a perspective representation of a root portion of a wind turbine tower, in the process of installing apparatus for constructing the wind turbine tower, according to an embodiment of the invention;

FIG. 4 is a perspective representation of the root portion of the wind turbine tower, in the process of installing apparatus for constructing the wind turbine tower, at a further stage of the installation;

FIG. 5 is a close-up representation of the area D in FIG. 4;

FIG. 6 is a close-up representation of the area A in FIG. 4;

FIG. 7 is a perspective view of an part of the support frame of elevation means of the installed apparatus depicted in FIG. 4 to extend around the root portion of the wind turbine tower;

FIG. 8 is a perspective view in close up of area B in FIG. 4 showing an upper end of the root portion of the wind turbine tower with extendable gripper elements on the support frame of FIG. 7;

FIG. 9 is a representation of the area C of FIG. 8 showing one of the extendable gripper elements in close up;

FIG. 10 is a perspective representation of the root portion of the wind turbine tower, in the process of installing the apparatus for constructing the wind turbine tower at a yet further stage of the installation;

FIG. 11 is a perspective representation of a part of a tower section of the crane tower of the apparatus undergoing installation in FIG. 10;

FIG. 12 is a close-up representation of the area A of FIG. 10, showing detail including stand-off rollers on a tower section of the crane tower;

FIG. 13 is a close-up representation of the area B of FIG. 10 showing detail including winch cable connection points for operating the lifter of the elevation means;

FIG. 14 is a close-up representation of the area C of FIG. 12 showing one of the stand-off rollers in further detail;

FIG. 15 is a close-up representation of the area D of FIG. 11 showing a formation extending around the an upper end of the part of the crane tower section for facilitating engagement with the gripper element of the elevation means;

FIG. 16 is a side representation of the root portion of the wind turbine tower of FIG. 10 with the apparatus installed ready for further assembly of the wind turbine tower;

FIG. 17 is a side representation of the root portion of the wind turbine tower of FIG. 16 with the crane of the crane tower of the apparatus positioning a further wind turbine tower section above the upper end of the root portion of the wind turbine tower for connection thereto to extend the wind turbine tower, in the construction of the wind turbine tower;

FIG. 18 is a side representation of the wind turbine tower under construction the further section of FIG. 17 having been connected, and after lifting the crane tower upwards along the wind turbine tower using the elevation means of the apparatus;

FIG. 19 is a side representation of the wind turbine tower of FIG. 18 under construction, after lowering the lift of the elevation means and after arranging elements of an extension section of the crane tower around the wind turbine tower, below the lower end of the elevated crane tower;

FIG. 20 is a close-up representation of the area B of FIG. 18 showing the lifter of the elevation means and elevated tower section in an elevated position;

FIG. 21 is a perspective representation of a part of the extension section of the crane tower provided around the wind turbine tower in FIG. 19;

FIG. 22 is a part of the carriage of the lifter to extend around the support frame of the elevation means and around the root portion of the wind turbine tower as seen in installed apparatus of preceding figures;

FIG. 23 is side representation of the wind turbine under construction at a stage further from that of FIG. 19, after positioning a yet further tower section of the wind turbine tower above an upper end of the installed portion of the wind turbine tower and connecting the yet further tower section thereto, and after lifting the crane tower upwards along the installed portion of the wind turbine tower;

FIG. 24 is a sectional side representation of the wind turbine tower under construction at the stage of FIG. 23, along the line D-D of FIG. 23;

FIG. 25 is a close up of an engager of the elevation means in locking engagement with a tower section of the crane tower for locking or holding the crane tower in elevated position;

FIG. 26 is a perspective view of the wind turbine tower under construction at the stage of FIG. 23;

FIG. 27 is a cross sectional representation of the tower under construction with the apparatus along the line C-C of FIG. 23;

FIG. 28 is a side representation of the wind turbine under construction, after a further extension section of the crane tower is connected and inserted to extend the crane tower which is supported on the root portion of the wind turbine on a platform extending radially and around the root portion, the wind turbine tower having been assembled using the crane tower, the nacelle having been connected to the upper end of the wind turbine tower, and with a rotor blade being lifted upwards for arranging the blade for connection to the nacelle; and

FIG. 29 is a perspective view of the wind turbine under construction at the stage of FIG. 28; and

FIG. 30 is a close-up view of the area A of FIG. 28 showing the coupling of the blade to a counterweighted lifting yoke.

### DETAILED DESCRIPTION OF THE EMBODIMENTS

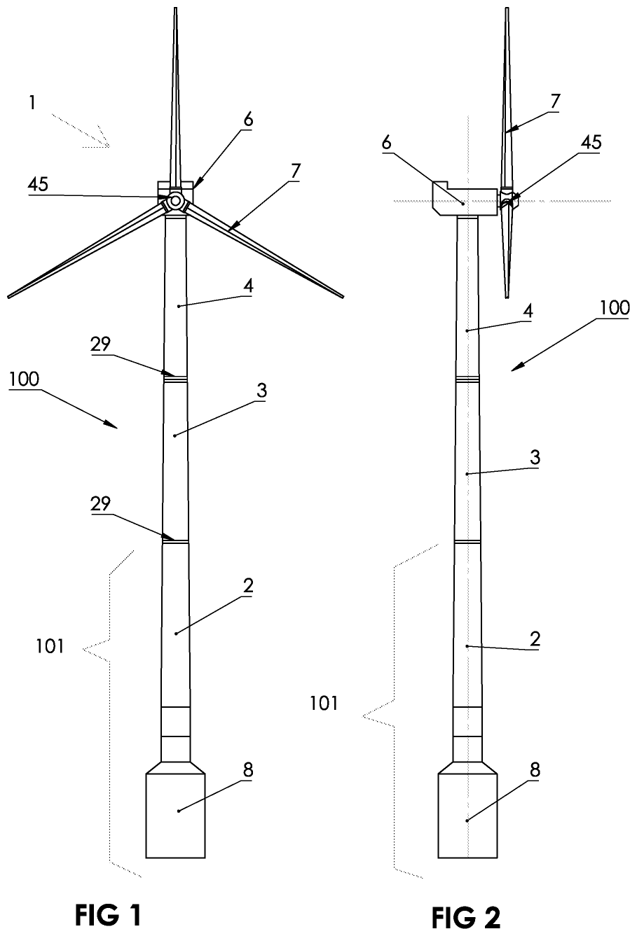

Referring first to FIGS. 1 and 2, a fully constructed wind turbine 1 is depicted. The wind turbine 1 has wind turbine tower 100 including a root portion 101 comprising a foundation 8 and a lower tower section 2. The foundation 8 can vary in form depending for example upon whether the wind turbine is a floating wind turbine, a fixed seabed wind turbine, or a land wind turbine. The present example is for illustrative purposes a floating wind turbine 1, with the root portion 101 extending through the surface of the water (not shown). At least the lower part of the foundation 8 is submerged and the lower tower section 2 extends vertically upward from the sea surface. The construction of the wind turbine 1 as will be explained further below involves first installing the root portion 101. The remainder of the wind turbine 1 is then constructed using apparatus supported upon the root portion 101.

As can be appreciated in FIGS. 1 and 2, the wind turbine tower 100 includes in the upward direction from the foundation 8 a tower section 2, a further tower section 3, and a yet further tower section 4. In this example, just three tower sections are provided, not counting the foundation 8. The tower sections 2, 3, 4 are elongate frustoconical tapered sections that connect one to the other end-to-end at connecting joints 29. The resulting tower 100 between the foundation 8 gradually tapers, i.e. reduces in outer diameter toward the upper end.

A nacelle 6 is arranged on an upper end of the wind turbine tower 100. Three blades 7 are connected to a hub 45 on the nacelle 6 having an axis of rotation typically horizontal or near horizontal in use. The blades 7 connect at connection points spaced apart around the hub at equal angle intervals. The blades 7 extend radially away from the hub of the nacelle 6. The set of blades 7 rotate about the axis of rotation for turning a shaft and driving a generator in the nacelle 6.

The construction of the wind turbine 1 will now be described. The construction of the wind turbine 1 is facilitated by apparatus which is installed and supported on the root portion 101 of the wind turbine tower 100 and which includes a crane 201 that is supported at an upper end of a crane tower 200. The crane tower 200′ can be extended along the wind turbine tower 100 in stages as the wind turbine tower is assembled. The apparatus includes a base for the crane tower and extended crane tower in the form of a platform 10 on the root portion 101 of the partially constructed wind turbine tower 100. The apparatus also includes elevation means 300 including a lifter for lifting the crane tower 200 upward along the wind turbine tower 100 to an elevated position, and creating insertion space for inserting a crane tower extension sections 30 between the platform and the elevated crane tower 200 and adding the extension section 30 to the crane tower. Once added, the reach of the extended tower 200′ attainable from the base platform 10 is greater, so that the crane 201 can be employed for assisting with assembling a further wind turbine tower section to the wind turbine tower.

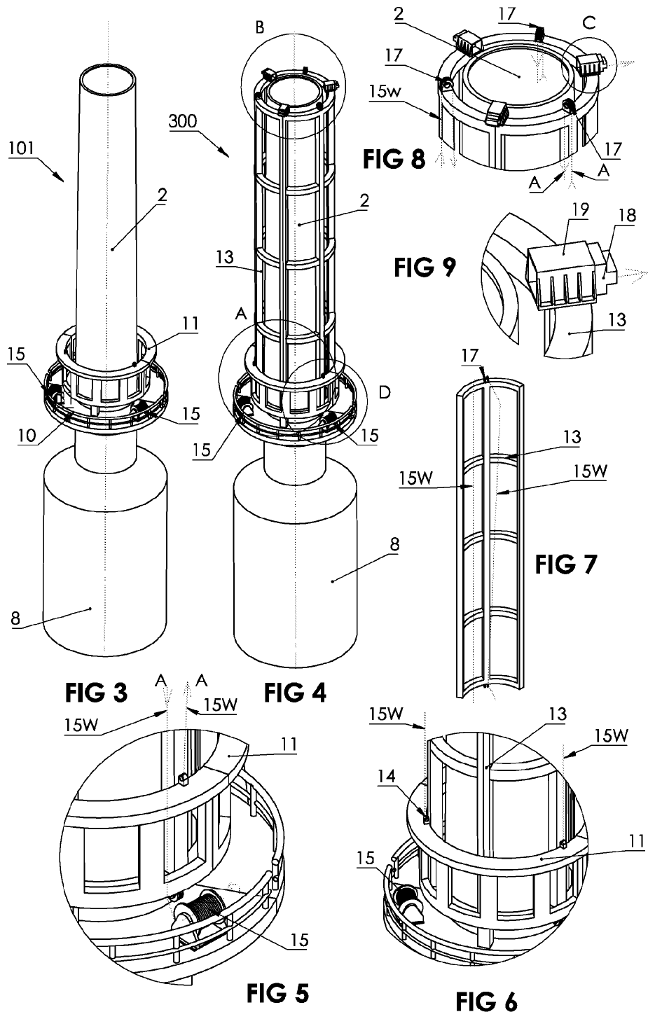

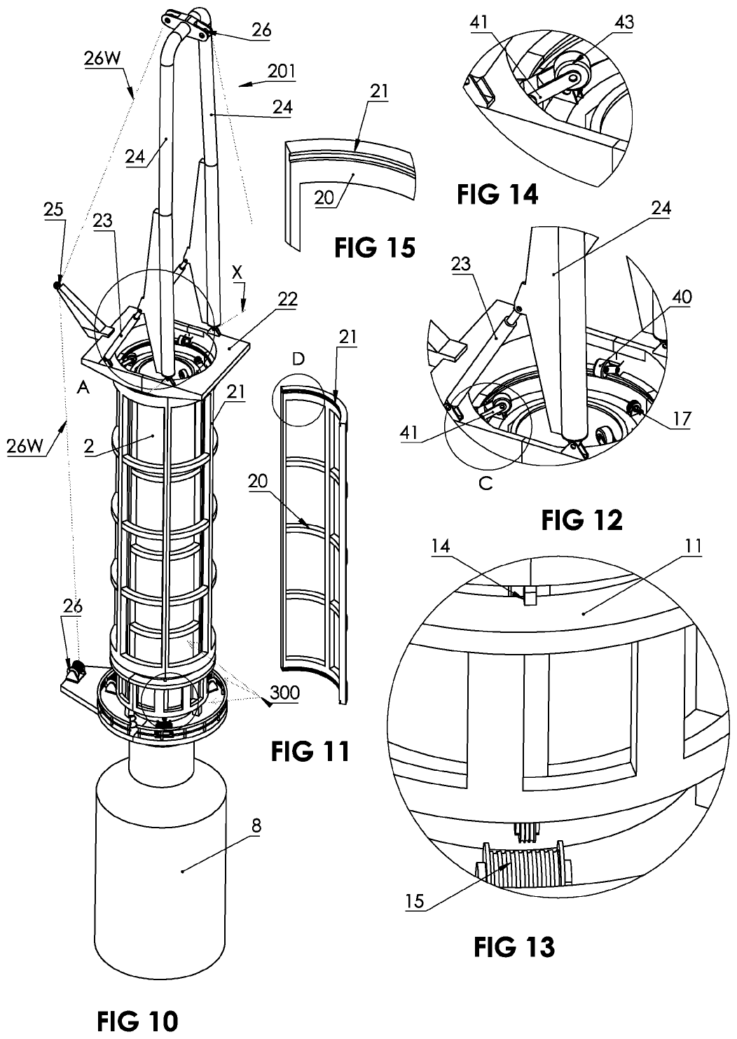

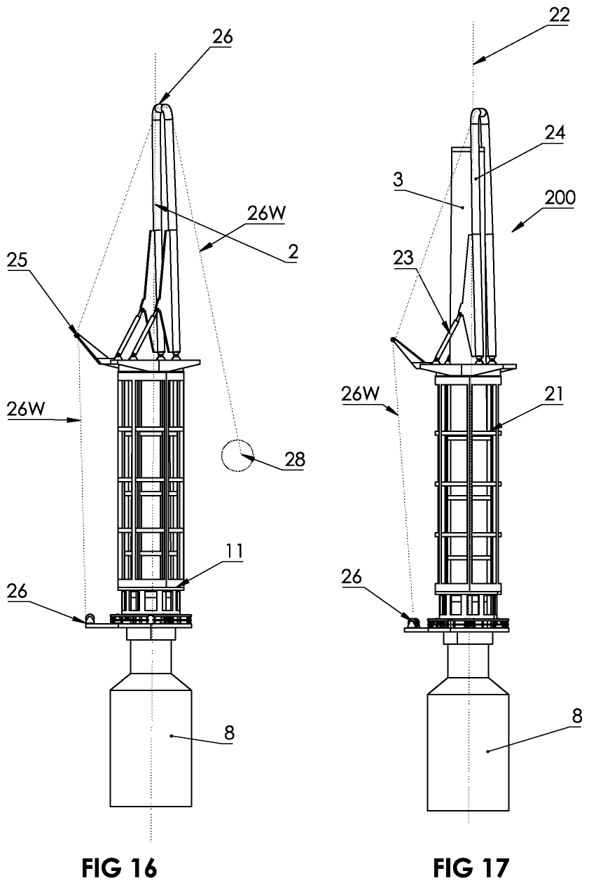

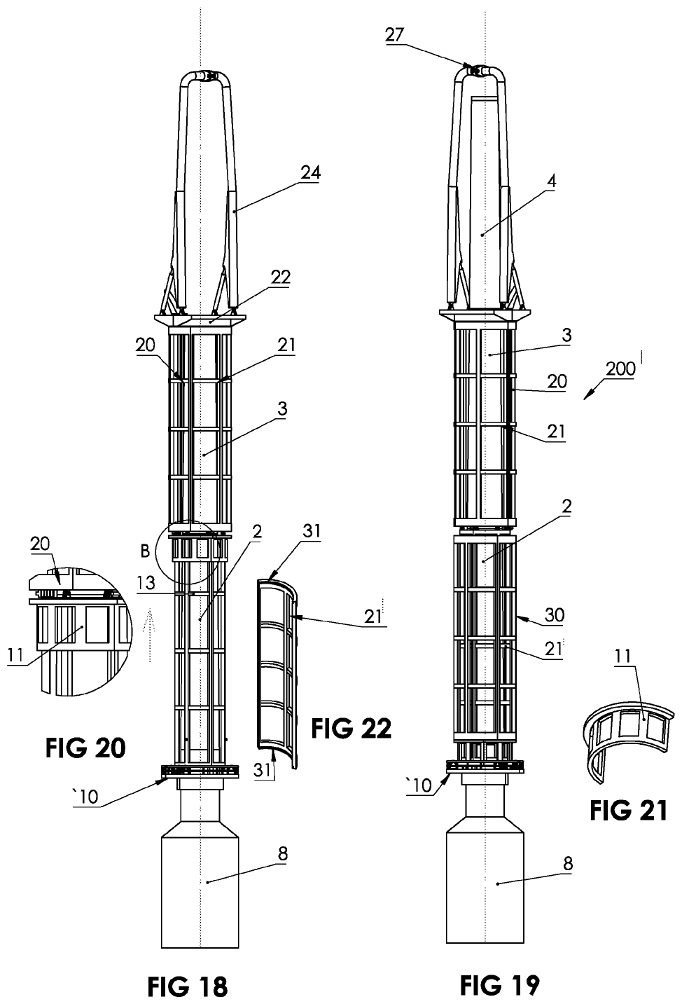

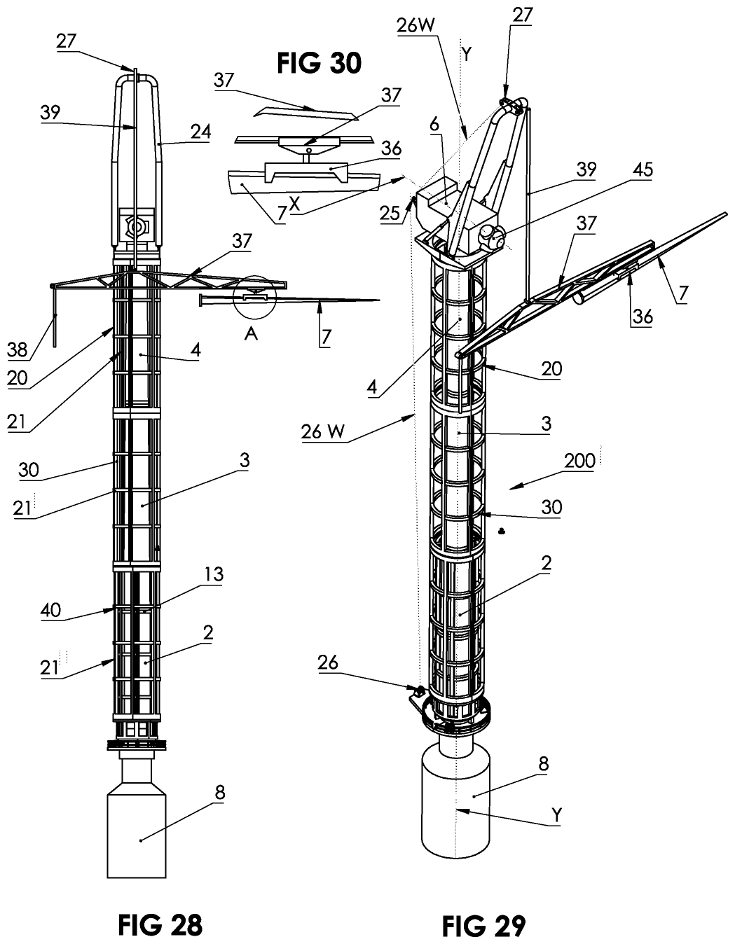

The construction of the wind turbine 1 can therefore be considered to include several stages:
i. providing the root portion 101;
ii. installing the elevation means 300 on the root portion 101 (FIGS. 3 to 9);
iii. installing the crane tower 200 of first length (which later is to be extended to greater length), providing the crane tower 200 with a crane 201 on an upper end thereof, the crane tower 200 to be supported upon the platform on the root portion 101, with a crane tower section 20 extending circumferentially around the root portion (FIGS. 10 to 16);
iv. extending the crane tower 200, the extended crane tower 200′ having a second length that is greater than the first length, using the crane 201 to add one or more further wind turbine tower sections 3, 4 to the wind turbine tower 100, the elevation means 300 being used to elevate the crane tower 200 and allow extension sections 30, 40 to be added to the crane tower 200 (FIGS. 17 to 27); and
v. using the crane 201 once the crane tower 200 has been fully extended, having a length extending from the platform 10 on root portion 101 to the upper end of the top tower section of the full length wind turbine tower 100, lifting the nacelle 6 to the upper end of the wind turbine tower 100 for connection thereto, and lifting the wind turbine blades 7 one by one to position the lifted blade 7 adjacent to the nacelle 6 for connection thereto (FIGS. 28 to 30).

The crane 201 can also be used for modification and maintenance operations on already constructed wind turbines. In those cases, the steps i. to iv. is carried out to extend the crane tower along the wind turbine tower, but without adding further wind turbine tower sections to the wind turbine tower 100 since it is already constructed. Once the crane 201 has been raised to the desired height, the crane 201 can be used to for example remove and replace one or more blades, or parts of the nacelle.

After the wind turbine 1 has been constructed, the fully extended crane tower 200″ is dissembled by using the elevation means 300 to hold the crane tower 200″ in position while decoupling and removing the lower crane tower extension section 40 of the crane tower 200, thereby shortening the crane tower, supporting and lowering the shortened crane tower 200′ from the elevated position to a lowered position, holding the crane tower 200′ in position using the elevation means 300, decoupling and removing the next extension section 30, further lowering the crane tower 200, etc.

As the crane tower 200 is built by from time to time inserting and adding extension sections in created space between the platform 10 and crane tower to be extended, and by using equipment installed upon the platform or root portion to provide the necessary manipulation of the crane tower to create the space to insert and add the extension sections, the crane tower can be raised upward having cylindrical tower framework spaced apart from the further wind turbine tower sections 3, 4 and joints 29 to be assembled, without requiring to engage those further sections 3, 4 in weight bearing relationship. Accordingly, the construction technique of building the crane tower 200 “bottom up” from the platform or defined base location upon the initially installed root portion, can be well suited for applications where tower sections 3, 4 of the wind turbine tower 100 are tapered. It may also be convenient in general for all wind turbine types, but in particular those offshore.

Turning then to FIGS. 3 to 9, the method of installing the elevation means 300 is now further described. The elevation means 300 includes a lifter which in this example is in the form of a carriage 11 operable by winches 15. The root portion 101 of the wind turbine tower 100 includes the foundation 8 and a longitudinally extending section 2 of the wind turbine tower, which are pre-installed at the installation site. The root portion 101 is provided with a base for the crane tower in the form of a platform 10 on the root portion. The platform 10 extends circumferentially around the root portion 101. The platform 10 extends radially outward with respect to an outer surface of the wind turbine tower section 2. The platform 10 has work deck or floor for operators. The platform 10 is rigidly and fixedly mounted on the root section in desired location.

The carriage 11 is arranged on the platform 10. The platform 10 has supports or a seat against which the carriage 11 rests in certain modes of use, as will be further described below. The winches 15 are also arranged on the platform 10. The carriage 11 comprises a frame which extends ring-wise around the tower section 2 of the wind turbine tower. The carriage 11 is assembled by connecting frame parts of the supporting frame to one another. The carriage 11 is arranged to be movable upward, away from the platform 10, and/or downward, toward the platform 10 along the tower section 2 of the root portion 101.

The elevation means 300 further includes support means in the form an elevation support frame 13 which extends around the tower section 2 in the root portion of the wind turbine tower. Parts of the elevation support frame 13 are arranged in an annular space between an inside of the frame of the carriage 11 and the outer surface of the tower section 2. The parts are connected to obtain the support frame 13 that is cylindrical and extends circumferentially around the wind turbine tower section 2. The elevation support frame 13 extends longitudinally along the tower section 2. The carriage 11 is arranged also to extend around the elevation support frame 13. The elevation support frame 13 is fixedly provided on the platform, and the platform 10 is fixedly provided upon the root portion of the wind turbine tower. Thus, the carriage 11 is movable upward/downward along the elevation support frame 13.

The elevation support frame 13 is a straight non-tapered cylindrical frame extending upward from the platform 10, whereas the tower section 2 tapers toward the upper end.

On the upper end of the support frame 13, disposed circumferentially thereupon with equal angular spacings and in different locations around the frame, locking means comprising engager devices 19 which have extendable members 18 are provided. The extendable members 18 are operable to extend outwardly from a housing to engage with a corresponding formation or member of a crane tower section of the elevated crane tower (to be described further below), so as to be capable of temporarily supporting the crane tower on the support frame 13 and locking against movement between the crane tower in the elevated position and the support frame.

The upper end of the support frame 13 is also provided with guides 17 for receiving the cables 15w from the respective winches 15. The cable 15w of each winch 15 extends from the winch 15 upward along an inside of the support frame 13, outward over the guides 17 and downward along an outside of the support frame 13 to the carriage 11 where the end of the cable 15w is attached to fastening lugs 14 on the carriage 11. Three winches 15 are fixedly installed on the platform 10, the cables 15w from the winches 15, pass under three lower guides, upward over the three guides 17, and connect to corresponding three lugs 14 on the carriage 11. Thus, by pulling in the cables in the direction as indicated by arrows A using the winches 15, the cable 15w from each winch 15 acts to pull the carriage 11 upward along the support frame 13. The three winches 15 can help to cope with large loads, distribute force and provide redundancy if one should break.

Turning then to FIGS. 10 to 16, steps of providing and arranging the crane tower 200 in an initial configuration, before the crane is used for work in assembling the wind turbine tower, are now described. The crane tower 200 comprises a crane 201 and a crane tower section 20. Parts of the crane tower section 20 are arranged around the wind turbine tower and are coupled together. The crane tower section 20 is in the form of an elongate cylindrical frame which extends alongside the tower section 2 of the wind turbine tower. The frame is a straight cylinder. The crane tower section 20 is arranged so as to extend around the support frame 13 of the previously assembled elevation means 300. The crane 201 has a crane base 22 that is connected to an upper end of the crane tower section 20. The lower end of the crane tower section 20 is supported upon the carriage 11. The weight of the crane tower 200 including the crane 201 is supported and transferred through the tower section section 20 and the carriage 11 and through the platform 10 to the root portion 101 of the wind turbine tower. The cylindrical frame of the crane tower section 20 has diametric match with the support frame of the carriage 11 which in turn rests supportingly upon the platform 10. Force imparted through the weight of the crane tower is transferrable therefore directly downwards vertically through the matching frames of the tower section 20 and the carriage 11, and the platform 10 to the root portion 101, and can provide a strong and materials efficient construction of the crane tower 200. In this configuration, the crane tower 200 is arranged in a base position, and the crane is operable in work mode for adding a further wind turbine tower section to the partially constructed wind turbine tower.

The crane 201 has an A-frame or inverted U or V frame boom 24 which is pivotally coupled to the crane base 22. The crane base is in the form of a ring and has an opening corresponding in diameter to diameter of the crane tower section 20. The opening allows access to the upper end of the partially constructed wind turbine tower. The boom 24 has legs rising upward either side of the crane base 22 and a transverse beam between the upper ends of the legs for bridging across and positioning top guide 27 for the crane wire 26w over the opening. The boom 24 is arranged to pivot about a horizontal axis X under control of linear hydraulic actuator cylinders 23 which act between the crane base 22 and the legs 24a, 24b of the boom 24. The crane 201 is also rotatable around a vertical axis on the crane base 22.

A crane winch 26 is provided on the platform 10 and the wire 26w from the crane winch 26 is passed through guide 25 on an arm extending radially outwardly from the crane base 22 of the crane 201 and passed onward upwardly from the guide 25 over the top guide 27 on the boom 24 for suspending loads 28 on the wire 26w over the top guide 27 from the boom 24. The boom 24 is configured to have a reach upward from the crane base 22 exceeding the length of the further tower sections 3, 4, to be added to the wind turbine tower. In this way, the boom 24 can suspend a further tower section 3, 4 that needs to be added in upright orientation over the upper end of the partially constructed tower, and can lower the tower section 3, 4 through the opening onto the upper end, by paying out the wire 26w.

The crane base 22 is provided with stand-off members 41 which protrude radially inwardly at distributed locations around an inside circumference of the crane base 22. In other variants, stand-off members 41 are alternatively or additionally provided on the crane tower sections 20, 30, 40 of the crane tower. The stand-off members 41 can facilitate centralisation of the crane tower 200 with respect to the wind turbine tower 100. They can provide stand-off between the crane tower 200 and the wind turbine tower 100 under construction in the event of adverse forces. They can facilitate proper positioning of the crane tower 200 with respect to the wind turbine tower under construction, which may help positioning the crane tower 200 when assembling and connecting further extension tower sections 30, 40 to the crane tower 200 and further tower sections 3, 4 to the wind turbine tower 100. The stand-off members 41 each comprises a spring-loaded arm which is biased to pivot inwardly to adapt to varying distances between the outer surface of the wind turbine tower and the crane tower, and the distance may vary and become larger toward the upper end of the wind turbine tower due to the upward taper. The stand-off members 41 each have a roller wheel 42 on the end of the arm for contacting an outer surface of the installed portion of the wind turbine tower under construction. The roller wheels 42 roll on the outer surface of the wind turbine tower upon lifting the crane tower 200 upward along the wind turbine tower 100 into the elevated position.

Turning now to FIGS. 17 to 27, the steps of extending the length of the crane tower upward from the root portion, using the crane to add one or more further tower sections to the wind turbine tower, using the elevation means being to elevate the crane tower and allow further support sections of the crane tower to be added to the crane tower to obtain an extended reach from the platform 10 is now further described.

The crane 201 is first used in work mode to suspend a further tower section 3 on the wire 26w over an upper end of the tower section 2 of the partially constructed wind turbine tower. Once positioned, the tower sections 2, 3 are connected to one another, end-to-end, thereby lengthening the wind turbine tower.

It is then sought to position the crane 201 at the upper end of the further tower section 3 and connect a yet further tower section 4 to the wind turbine tower. For this purpose, the crane tower 200 is extended, by insertion of a crane tower extension section in created space around the root portion 101 at or near the platform 10 and connecting the tower extension section 30.

The elevation means 300 is then used. More specifically, the carriage 11 is operated (by the winches 15) so that it is moved upward along the elevation support frame 13 and along the tower section 2 of the root portion 101 of the wind turbine tower. The carriage 11 is operated by activating the winches 15 to pull in the winch cables 15w. The crane tower 200 to be extended is driven and translated linearly and axially upward on the carriage 11. At the end of the travel, the crane tower 200 obtains an elevated position, and the engager members 19 of the locking means are operated for locking the crane tower to the elevation support frame 13, whereby the end members 18 engage with a circumferential groove formation 31 of the parts 21 of the crane tower section 20. By operation of the engagers 19, the end 18 is urged into the grove formation 31, and the elevated crane tower 200 is fixedly held with respect to the elevation support frame 13 of the elevation means 300. While being held in place by the engages, the carriage 11 is decoupled from the tower, and returned downward to the platform by operation of the winches 15. Space is created between the carriage 11 and the crane tower in the elevated position, when the carriage 11 is seated back upon the platform 10.

The extension section 30 of the crane tower 200 is then assembled. Parts 21′ of the extension section 30 are arranged in the created space around the tower section 2 of the wind turbine tower 100 and are coupled together. The extension section 30 is in the form of an elongate cylindrical frame which extends along the tower section 2 of the wind turbine tower. The frame is a straight cylinder. The extension section 30 is arranged so as to also extend around the elevation support frame 13 of the previously assembled elevation means 300. The lower end of the extension section 30 is arranged to be supported upon the carriage 11 resting upon the platform 10.

The upper end of the extension section 30 is coupled, end-to-end to the lower end of the crane tower section 20 of the crane tower in the elevated position. The lower end of the extension section 30 is supported upon the carriage 11. In this way, the addition of the further extension section 30 to the crane tower 200 extends the length of the crane tower 200 along the partially constructed wind turbine tower 100. After the extension section 30 is added, the engagers 19 are disengaged from the crane tower, unlocking it from the elevation frame 13, for permitting further extension of the crane tower. Forces imparted by the crane 201 and loads suspended therefrom e.g. during lifts of wind turbine tower sections or other components of the wind turbine to be installed, are transferred and supported directly through the end to end connected crane tower section 20, extension section 30, carriage 11 and platform 10 to the root portion 101 of the wind turbine tower 100. No further load-bearing connection to the wind turbine tower 100 is required.

The crane 201 is then used as seen in FIG. 19 to suspend and position the yet further tower element 4 above the upper end of previously installed tower section 3 of the wind turbine tower 100. The yet further wind turbine tower section 4 is installed in the same way as described above for the tower section 3.

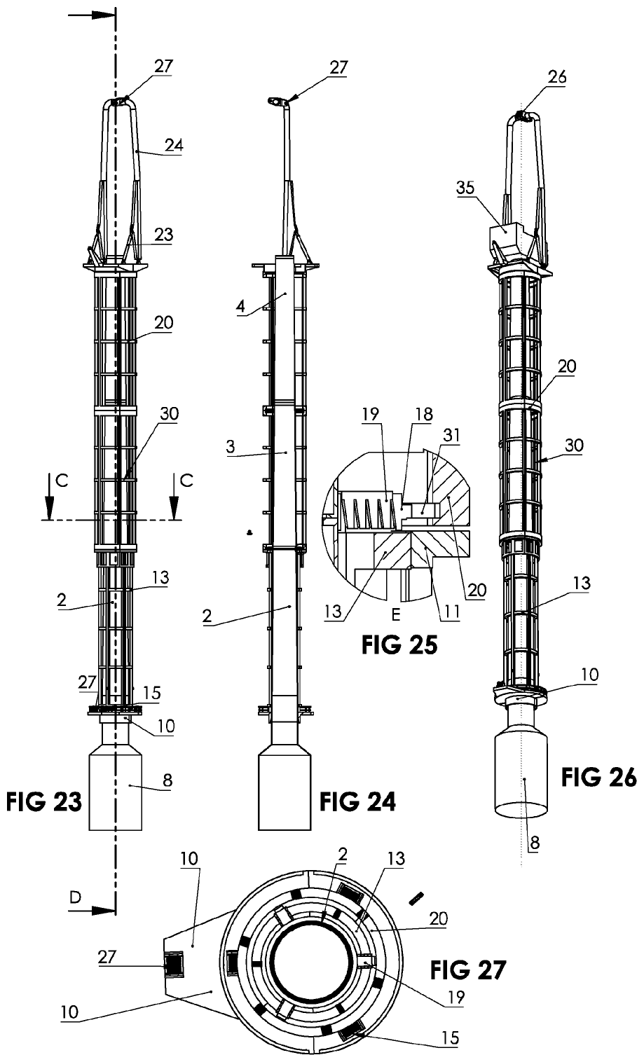

Then, as seen in FIG. 23, after the yet further tower section 4 is connected onto the end of the partially constructed wind turbine tower 100 thereby extending it further, the elevation means 300, in particular the carriage 11 and engagers 19, are once again employed to elevate the lengthened crane tower 200′ to an elevated position. In the elevated position, the crane base 22 is positioned near the top of the yet further wind turbine tower section 4 for allowing the crane 201 access to the upper end of the further tower section 4. Insertion space is created around the tower section 2 of the root portion of the wind turbine tower for inserting a further crane extension section 40 in the created space between crane tower 200′ and the platform 10. The engagers 19 on the elevation support frame 13 engage the extension tower section 30 to hold the lengthened crane tower 200′ in the elevated position whilst the further extension section 40 is arranged around the section 2 of the wind turbine tower and are connected in the same way as described above in relation to earlier extension section 30 of the crane tower.

Turning to FIGS. 28 to 30, the crane tower 200″ is fully extended with the crane 201 arranged to access the upper end the wind turbine tower 4. The wind turbine tower 100 is assembled to full length. The crane extension section 30 and further crane extension section 40 are incorporated so that the crane tower has attained full reach along the wind turbine tower 100 from the platform with the base at the top end of the wind turbine tower. The crane tower 200 is supported through the extension sections 30, 40, the carriage 11 and platform 10 to the root portion 101 of the wind turbine tower 100.

In this configuration, the crane 201 in use mode is then used for the lifting and assembly of the further components of the wind turbine 1, in particular the nacelle 6 and the blades 7. The nacelle 6 is installed on rotatable base on an upper end of the wind turbine tower in the space between legs of the boom 24. The blades 7 are hoisted up to the top of the tower on the crane wire 26w of the crane 201.

The end of the crane wire 26w is connected to a rod 39 which is suspended vertically from the boom 24 and the rod 39 in turn is connected to a lifting beam 37 extending transverse, i.e. horizontally, to the rod 39. The wind turbine blade 7 is coupled to one end of the lifting beam 37 via a mount 36 and obtains a horizontal orientation so that a longitudinal axis of the turbine blade 7 is horizontal to a longitudinal horizontal axis of the beam 37. The other end of the beam 37 is counterweighted by a counterweight 38. The blade 7 can by spooling in the length of wire 36w suspended from boom 24 therefore be manoeuvred and positioned near the hub 45 of the nacelle 6 in suitable orientation for connection of the connecting end of the blade 7 to the hub 45. The crane can be rotatable about a vertical axis Y upon the crane base 22.

After the blades 7 have all been connected, the crane 201 and crane tower 200″ is lowered and disassembled by carrying out the steps for extending and elevating the crane tower in reverse order. Thus, the crane tower 200″ can be shortened and lowered by removal of the bottom extension section 40 whilst the remainder of the crane tower 200′ from which the extension section 40 is removed is supported and locked in position to the elevation support frame 13 by the engagers 19. The crane boom 24 is positioned so as to leave the opening of the crane base 22 unobstructed, allowing the lowering of the crane tower with the wind turbine extending through the opening. The elevation means 300 and platform 10 are removed from the root portion 101 of the wind turbine tower, and the fully constructed wind turbine 1 as depicted in FIGS. 1 and 2 is obtained.

The crane 201 and the crane tower 200 can be used to perform various modification and maintenance operations, such as removing and/or replacing one or more blades 7 or removing and/or replacing the whole or portions of the nacelle 6, such as a gear or a generator. In this case, the crane tower 200 is installed and lengthened along an existing wind turbine tower. When the crane 201 reaches the desired height, the desired lifting operation can be performed by using the crane 201 on the extended crane tower 200.

In some variants, the assembly process starts with lifting and installing a unit comprising a tower section with the platform, support means, and lifter attached, onto the foundation. The crane is thereafter arranged on the lifter.

Various modifications and improvements may be made without departing from the scope of the invention herein described.

1-47. (canceled)

48. A method of extending a crane tower along a wind turbine tower, the crane tower being supported upon the wind turbine tower, the wind turbine tower including a foundation, the method comprising the steps of:
providing, on the wind turbine tower:
a crane tower to be extended along at least a portion of the wind turbine tower, the crane tower comprising one or more crane tower sections and a crane at or near an upper end thereof;
support means; and
at least one lifter;
locating the crane tower in a base position, in which a lower end of the crane tower is arranged at or near a crane tower base which is supported upon the wind turbine tower;
operating the lifter to elevate the crane tower away from the crane tower base toward an elevated position, thereby creating space for one or more crane tower extension sections to be inserted at or near the crane tower base;
supporting the crane tower in the elevated position using the support means;
arranging one or more crane tower extension sections in the created space; and
adding the one or more crane tower extension sections to a lower end of the elevated crane tower, thereby extending the crane tower.

49. The method as claimed in claim 48, wherein the one or more crane tower sections are configured to extend around the wind turbine tower and the one or more crane tower extension sections are configured to extend around the wind turbine tower.

50. The method as claimed in claim 49, wherein the one or more crane tower sections and the one or more crane tower extension sections are elongated sections to extend longitudinally along the crane tower.

51. The method as claimed in claim 48, which further comprises either or both of: connecting at least two parts to assemble the one or more crane tower sections; and connecting at least two parts to assemble the one or more crane tower extension sections.

52. The method as claimed claim 48, which further comprises:
locating the lengthened crane tower in the base position, in which a lower end of the lengthened crane tower is arranged at or near the crane tower base;
operating the lifter to elevate the lengthened crane tower away from the crane tower base toward an elevated position, thereby creating space for further extension tower sections to be inserted at or near the crane tower base;
locating and supporting the lengthened crane tower in the elevated position;
arranging one or more further extension sections in the created space in an area around the wind turbine tower; and
adding the one or more further extension sections to a lower end of the elevated crane tower, thereby further lengthening the crane tower.

53. The method as claimed in claim 48, comprising the steps of:
locating the lengthened crane tower in the base position, in which a lower end of the lengthened crane tower is arranged at or near the crane tower base; and
using the crane on the lengthened crane tower to perform a lifting operation.

54. The method as claimed claim 48, wherein the weight of the crane tower at least partially is transmitted to the wind turbine tower, through the crane tower base.

55. The method as claimed in claim 48, wherein the foundation of the wind turbine tower is one of: a floating foundation, a bottom fixed offshore foundation, a ground supported foundation.

56. The method as claimed in claim 48, wherein the wind turbine tower is an offshore wind turbine tower.

57. The method as claimed in claim 48, wherein the support means comprises a support frame which extends circumferentially at least partially around a portion of the wind turbine tower, and the method includes connecting at least two components to assemble the support frame.

58. The method as claimed in claim 48, wherein the lifter comprises a carriage arranged to travel longitudinally to move the crane tower from the base position to the elevated position.

59. The method as claimed in claim 48, wherein the lifter is arranged to extend circumferentially at least partially around a portion of the wind turbine tower.

60. The method as claimed in claim 58, wherein the support means comprises a support frame which extends in a circumferential direction at least partially around a portion of the wind turbine tower, and the lifter is arranged to extend circumferentially at least partially around an outside of the support frame, whereby a lower end crane tower section of the crane tower being elevated is arranged in abutment upon an upward facing surface of the support frame, and is engaged by the carriage, the carriage being movable up/down along the support frame.

61. The method as claimed in claim 48, wherein the weight of the support means is at least partially transmitted to the wind turbine tower, through the crane tower base.

62. The method as claimed in claim 48, wherein supporting the crane tower in the elevated position, comprises locking the crane tower to the support means.

63. The method as claimed in claim 48, which further comprises operating the crane to:
locate and position a wind turbine tower section in longitudinal orientation above an upper end of a previously installed tower section of the wind turbine tower, and connecting the wind turbine tower section to the upper end; or
locate and position the whole or at least a part of a nacelle above an upper end of a wind turbine tower section for connection thereto; or
lift a wind turbine blade adjacent to the nacelle for connection thereto; or
either or both remove and replace parts of a wind turbine; or
either or both remove and replace at least one of a blade and parts of or the whole of the nacelle; or
perform at least one of: a wind turbine installation operation; a wind turbine modification operation; and a wind turbine maintenance operation.

64. An apparatus configured to be provided on a wind turbine tower, the apparatus comprising:
at least one crane tower section to extend at least partially around a wind turbine tower section;
a crane configured to be coupled to and supported upon an upper end of the at least one crane tower section;
a support structure to extend at least partially around a wind turbine tower section;
a lifter for advancing a crane tower including the at least one crane tower section and the crane away from or towards a first, base position along a wind turbine tower;
means for supporting the crane tower in a second position; and
at least one crane tower extension section to extend at least partially around a wind turbine tower section;
wherein the lifter is configured to advance the crane tower, in a first mode, away from the first, base position toward the second position to create space for inserting the at least one crane tower section into the created space, and the at least one crane tower extension section is configured to be arranged in the space and connected to the crane tower in order to extend the crane tower.

65. The apparatus as claimed in claim 64, wherein the at least one tower extension section is configured to be disconnected and removed from the crane tower in order to shorten the crane tower and the lifter is configured to advance the crane tower, in a second mode, away from the second position toward the first, base position.

66. The apparatus as claimed in claim 64, wherein the crane is configured to suspend a wind turbine tower section in vertical orientation above an upper end of the crane tower.

67. A method of extending a crane tower along a wind turbine tower, the method comprising the steps of:
providing a crane tower to be extended along at least a portion of a wind turbine tower, the crane tower comprising one or more crane tower sections configured to extend around the wind turbine tower, and a crane at or near an upper end thereof, and providing support means and at least one lifter;
locating the crane tower in a base position, in which a lower end of the crane tower is arranged at or near a crane tower base;
operating the lifter to elevate the crane tower away from the crane tower base toward an elevated position, thereby creating space for one or more crane tower extension sections to be inserted at or near the crane tower base;
locating and supporting the crane tower in the elevated position using the support means;
arranging one or more crane tower extension sections in the created space; and
adding the one or more crane tower extension sections to a lower end of the elevated crane tower, thereby extending the crane tower:
the one or more crane tower extension sections configured to extend around the wind turbine tower.

68. The method as claimed in claim 67, which further comprises arranging parts for forming the one or more crane tower extension sections in the created space, assembling the one or more crane tower extension sections by connecting the parts.

69. The method as claimed in claim 67, wherein the crane has a crane base at an upper end of the one or more crane tower sections and a boom extending from the crane base.

70. A method of constructing a wind turbine tower, the method comprising the steps of:
providing a crane tower to be extended along at least a portion of the wind turbine tower under construction, the crane tower comprising one or more crane tower sections and a crane at or near an upper end thereof, and providing support means and at least one lifter;
locating the crane tower in a base position, in which a lower end of the crane tower is arranged at or near a crane tower base;
using the crane tower in work mode, operating the crane to locate and position a wind turbine tower section in longitudinal orientation above an upper end of a partially constructed portion of the wind turbine tower, the wind turbine tower section in longitudinal orientation being lowered vertically into the upper end of the crane tower;
operating the lifter to elevate the crane tower away from the crane tower base toward an elevated position, thereby creating space for crane tower extension sections to be inserted at or near the crane tower base;
locating and supporting the crane tower in the elevated position;
arranging one or more crane tower extension sections in the created space; and
adding the one or more crane tower extension sections to a lower end of the elevated crane tower, thereby extending the crane tower.

71. The method as claimed in claim 70, wherein the crane has a crane base at an upper end of the one or more crane tower sections and a boom extending from the crane base, the crane base having an opening for receiving a wind turbine tower section therethrough and the method includes lowering the wind turbine tower section in longitudinal orientation vertically through the opening of the crane tower base into the upper end of the crane tower and toward the upper end of the partially constructed portion of the wind turbine tower.

72. The method as claimed in claim 70, wherein the crane tower, support means, and the lifter are arranged on the wind turbine tower.

73. A method of constructing a wind turbine tower, the method comprising the steps of:
providing a crane tower to be extended along the wind turbine tower under construction, the crane tower being supported upon a partially constructed portion of the wind turbine tower, the crane tower comprising one or more crane tower sections and a crane at or near an upper end thereof, the partially constructed portion of the wind turbine tower being equipped with apparatus comprising at least one lifter and support means, the partially constructed wind turbine tower including a foundation;
locating the crane tower in a base position, in which a lower end of the crane tower is arranged at or near and in weight bearing relationship upon a crane tower base, the weight of the crane tower at least partially transmitted to the partially constructed portion of the wind turbine tower, for example to the foundation thereof, through the crane tower base;
using the crane tower in work mode, operating the crane to locate and position a further wind turbine tower section in longitudinal orientation above an upper end of the partially constructed portion of wind turbine tower, and connecting the further wind turbine tower section to the upper end;
operating the lifter to elevate the crane tower away from the crane tower base toward an elevated position, thereby creating space for crane tower extension sections to be inserted at or near the crane tower base;
locating the crane tower in the elevated position, locking the crane tower to the support means, the weight of the crane tower at least partially transmitted to the partially constructed portion of the wind turbine tower, for example to the foundation thereof, through the support means and optionally further through the crane tower base;
arranging one or more crane tower extension sections in the created space in an area around the partially constructed portion of the wind turbine tower; adding the one or more crane tower extension sections to a lower end of the elevated crane tower, thereby lengthening the crane tower;
locating the lengthened crane tower in the base position, in which a lower end of the lengthened crane tower is arranged at or near and in weight bearing relationship upon the crane tower base, the weight of the lengthened crane tower at least partially transmitted to the partially constructed portion of the wind turbine tower, for example to the foundation thereof, through the crane tower base; and
using the lengthened crane tower in work mode, operating the crane to locate and position a further wind turbine tower section in longitudinal orientation above an upper end of the previously connected tower section of the wind turbine tower, and connecting the further wind turbine tower section to the upper end.

74. The apparatus as claimed in claim 64, for facilitating in assembling a wind turbine tower, and wherein the crane is configured to suspend a wind turbine tower section in vertical orientation above an upper end of the crane tower.

75. The apparatus as claimed in claim 74, wherein the crane has a crane base having an opening for receiving therethrough vertically upon lowering a wind turbine tower section.
